(19) United States
(12) Patent Application Publication
(10) Pub. No.: US 2025/0256655 A1
(43) Pub. Date: Aug. 14, 2025

(54) MOUNTING APPARATUS FOR VEHICLES

(71) Applicant: Rivian IP Holdings, LLC, Irvine, CA (US)

(72) Inventors: Haley Lauren BROOKS, Encino, CA (US); Matthew MATERA, Newport Beach, CA (US); Steven Digby NICOL, San Clemente, CA (US); Lindsey Michelle CROSS, Dana Point, CA (US); William Kirk ROBINSON, Newport Beach, CA (US); Kaitlyn OLAH, Irvine, CA (US); Paula Michelle LOBACCARO, San Clemente, CA (US)

(21) Appl. No.: 18/440,950

(22) Filed: Feb. 13, 2024

(51) Int. Cl. B60R 9/058

(52) U.S. Cl. CPC B60R 9/058

(57) ABSTRACT

The present disclosure relates to mounting apparatus, and related methods and components, for mounting an accessory to a mounting structure. In one or more embodiments, the mounting structure is a crossbar and/or a rail of a vehicle. In one or more embodiments, a mounting apparatus includes an actuator and a handle pivotably coupled to the actuator. The mounting apparatus also includes one or more locking pins. The handle is configured to rotate relative to a rotational axis and pivot relative to a pivot axis, and one or more links are disposed such that rotation of the handle moves the one or more links to rotate the one or more locking pins.

### INTRODUCTION

Accessories can be mounted to vehicles, such as on roofs of vehicles or in cabs of vehicles. However, the devices used for mounting can require tools and can be difficult to operate. Moreover, the devices can be difficult to dismount from vehicles, which can increase vehicle footprints and hinder aerodynamic efficiencies.

### SUMMARY

The present disclosure relates to mounting apparatus, and related methods and components, for mounting an accessory to a mounting structure. In one or more embodiments, the mounting structure is a crossbar of a vehicle and/or a rail of the vehicle.

In one or more embodiments, a mounting apparatus includes one or more locking pins, and one or more links. The mounting apparatus includes a handle configured to rotate and pivot. Rotation of the handle moves the one or more links to rotate the one or more locking pins into a blocking position relative to a mounting structure. Pivoting of the handle moves the locking pins toward the handle and into a locked position.

In one or more embodiments, a mounting apparatus includes one or more locking pins, and an actuator bar. The actuator bar is rotatable relative to a rotational axis to rotate the one or more locking pins and slidable along the rotational axis to slide the one or more locking pins. The mounting apparatus includes a plate disposed at least partially between the actuator bar and the one or more locking pins.

In one or more embodiments, a mounting apparatus includes an actuator and a handle pivotably coupled to the actuator. The mounting apparatus includes one or more locking pins. The one or more locking pins include one or more flange sections. Rotation of the handle rotates the one or more flange sections of the one or more locking pins, and pivoting of the handle slides the one or more locking pins.

In one or more embodiments a collapsible retention apparatus includes a first support rail, a second support rail spaced from the first support rail to define a spacing therebetween, and a shaft coupled to the first and second support rails. The shaft is rotatable relative to the first and second support rails. The collapsible retention apparatus includes a handle coupled to the shaft, and rotation of the shaft moves the handle into and out of the spacing.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting in scope, and may admit to other equally effective embodiments.

FIG. 1 is a schematic front view of a vehicle, according to one or more embodiments.

FIG. 2 is a schematic perspective view of the mounting apparatus shown in FIG. 1 in a first position, according to one or more embodiments.

FIG. 3 is a schematic perspective view of the mounting apparatus shown in FIG. 2 in a second position, according to one or more embodiments.

FIG. 4 is a schematic perspective view of the mounting apparatus shown in FIG. 3 in a third position, according to one or more embodiments.

FIG. 5 is a schematic cross-sectional side view, along Section 5-5 shown in FIG. 4, of the mounting apparatus, according to one or more embodiments.

FIG. 6 is a schematic perspective view of the mounting apparatus shown in FIGS. 2-5 with the second body and the plate hidden, according to one or more embodiments.

FIG. 7 is a schematic back view of the mounting apparatus shown in FIGS. 2-6, according to one or more embodiments.

FIG. 8 is a schematic enlarged partial perspective view of the mounting apparatus shown in FIGS. 2-5, according to one or more embodiments.

FIG. 9 is a schematic side view of the mounting apparatus in the first position shown in FIG. 2, according to one or more embodiments.

FIG. 10 is a schematic side view of the mounting apparatus in the second position shown in FIG. 3, according to one or more embodiments.

FIG. 11 is a schematic side view of the mounting apparatus in the third position shown in FIG. 4, according to one or more embodiments.

FIG. 12 is a schematic perspective view of a collapsible retention apparatus in a first position, according to one or more embodiments.

FIG. 13 is a schematic perspective view of the collapsible retention apparatus in a second position, according to one or more embodiments.

FIG. 14 is a schematic enlarged perspective view of the first support rail shown in FIG. 12, according to one or more embodiments.

FIG. 15 is a schematic side view of the mounting apparatus shown in FIG. 14 in a first position, according to one or more embodiments.

FIG. 16 is a schematic side view of the mounting apparatus shown in FIG. 15 in a second position, according to one or more embodiments.

FIG. 17 is a schematic side view of the mounting apparatus shown in FIG. 16 in a third position, according to one or more embodiments.

FIG. 18 is a schematic side cross-sectional view of the mounting apparatus along Section 18-18 shown in FIG. 14 in the third position, according to one or more embodiments.

FIG. 19 is a schematic bottom view of the mounting apparatus shown in FIG. 16 in the second position, according to one or more embodiments.

FIG. 20 is a schematic bottom view of the mounting apparatus shown in FIG. 17 in the third position, according to one or more embodiments.

FIG. 21 is a schematic bottom view of the first vehicle rail shown in FIGS. 12-14, according to one or more embodiments.

FIG. 22 is a schematic bottom view of the first vehicle rail shown in FIG. 21, according to one or more embodiments.

FIG. 23 is a schematic block diagram view of a method of mounting an accessory, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to mounting apparatus, and related methods and components, for mounting an accessory to a mounting structure. In one or more embodiments, the mounting structure is a crossbar and/or a rail of a vehicle. In one or more embodiments, the vehicle is an automotive vehicle, such as an electric vehicle (e.g., an electric truck, an off-road vehicle, a sport-utility vehicle (SUV), or a service van) or an internal combustion vehicle. Other vehicles are contemplated.

In one or more embodiments, a mounting apparatus includes an actuator and a handle pivotably coupled to the actuator. The mounting apparatus also includes one or more locking pins. The handle is configured to rotate relative to a rotational axis and pivot relative to a pivot axis, and one or more links are disposed to transfer rotational movement between the handle and the one or more locking pins.

In operation, a user can position one or more flange sections of the one or more locking pins into an opening of a crossbar and/or a rail. The user then rotates the handle. The rotation of the handle rotates the one or more locking pins so that the one or more locking pins extend into channel sections on opposite sides of the opening. After rotation of the handle, the handle is pivoted toward the housing, causing the one or more locking pins to abut against opposing plate sections of the crossbar and/or the rail and lock the mounting apparatus to the crossbar and/or the rail. An accessory (such as an awning or a spare tire) can then be mounted to the crossbar and/or rail. For example, an awning can be mounted to the housing using fasteners. As another example, a spare tire can be tied down to a collapsible retention apparatus coupled to the mounting apparatus.

The mounting apparatus enables a user to reliably, quickly, and easily mount an accessory to a vehicle. The mounting apparatus can be locked using one hand and without driving tools (such as a wrench or screwdriver). Additionally, the mounting apparatus can be quickly unlocked from the crossbar, which improves aerodynamics of the vehicle, allows the vehicle to move through smaller clearances, and allows the mounting apparatus to be more easily stored in the vehicle or another enclosed area.

The disclosure contemplates that terms used herein such as “couples,” “coupling,” “couple,” and “coupled” may include but are not limited to welding, fusing, melting together, embedding, bonding, interference fitting, and/or fastening such as by using bolts, threaded connections, rivets, pins, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links, brackets, blocks, and/or frames.

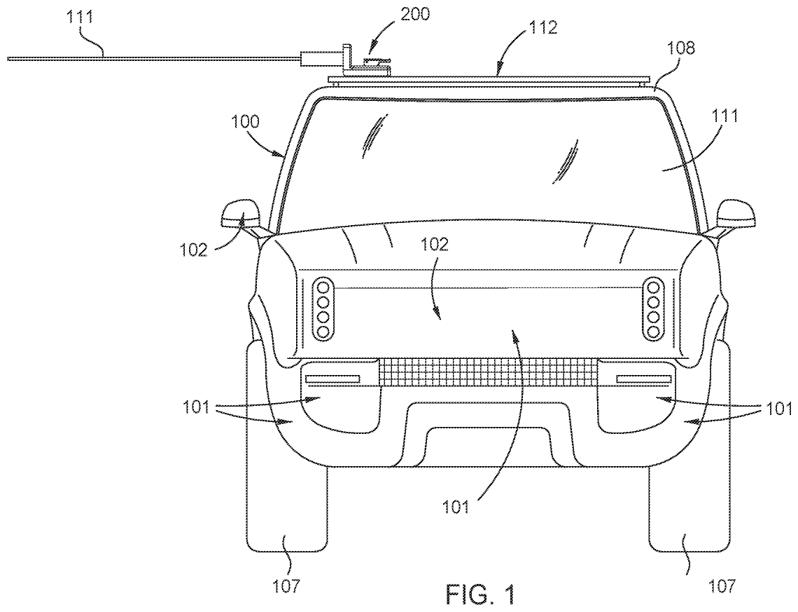

FIG. 1 is a schematic front view of a vehicle 100, according to one or more embodiments. The vehicle 100 may include multiple sensors 101 and/or multiple cameras 102. The vehicle 100 includes one or more wheel modules 107. In the implementation shown in FIG. 1, the vehicle 100 is a truck. The present disclosure contemplates that the subject matter described herein can be used in any other type of vehicle having any numbers of wheels, such as vans and/or SUVs. An accessory 111 is mounted to a mounting structure 112 of the vehicle 100. In one or more embodiments, the mounting structure 112 includes one or more crossbars. In one or more embodiments, the mounting structure 112 is mounted to a vehicle body 108 (such as a roof of the vehicle body 108) of the vehicle 100 using one or more mounting apparatus 200 (one mounting apparatus 200 is shown in the front view). In one or more embodiments, the accessory 111 is an awning. The present disclosure also contemplates that the accessory 111 can be a spare tire, a cooler, a fridge, and/or kitchen equipment. Other accessories are contemplated.

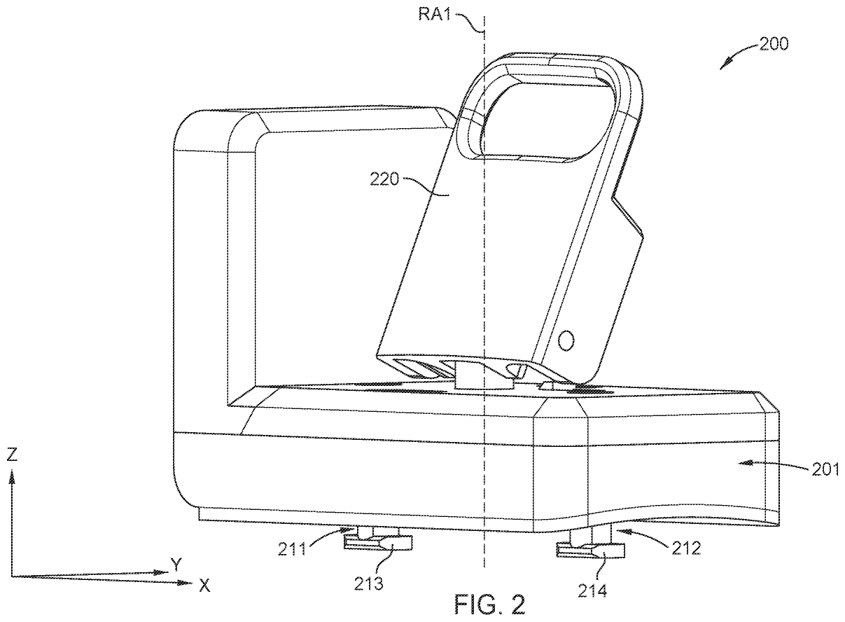

FIG. 2 is a schematic perspective view of the mounting apparatus 200 shown in FIG. 1 in a first position, according to one or more embodiments.

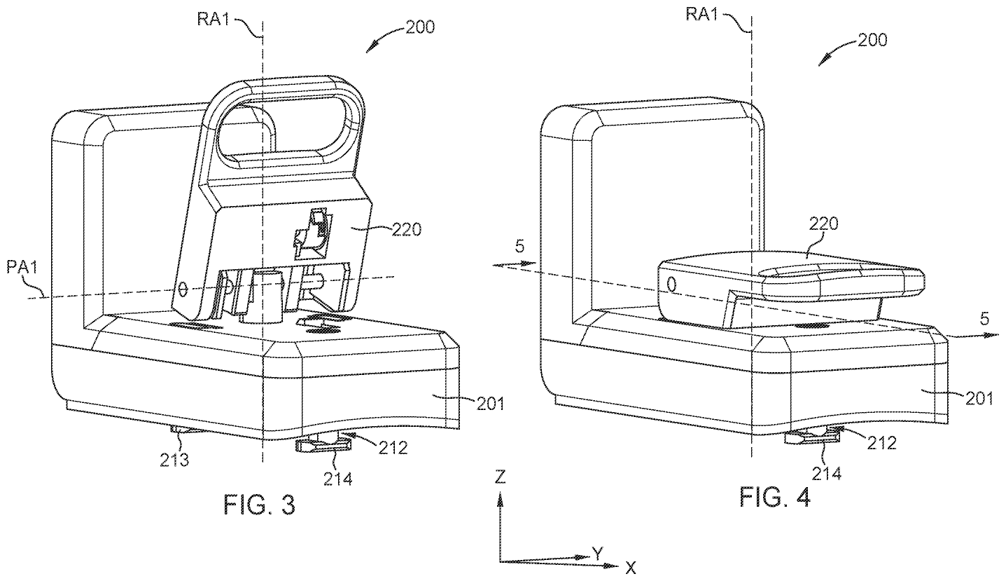

FIG. 3 is a schematic perspective view of the mounting apparatus 200 shown in FIG. 2 in a second position, according to one or more embodiments.

FIG. 4 is a schematic perspective view of the mounting apparatus 200 shown in FIG. 3 in a third position, according to one or more embodiments.

FIGS. 2-4 will be described together. The mounting apparatus 200 includes a housing 201 and one or more locking pins 211, 212 (two are shown) extending at least partially out of the housing 201 and at least partially into the housing 201. The mounting apparatus 200 includes a handle 220 configured to rotate relative to (e.g., about) a rotational axis RA1 and pivot relative to a pivot axis PA1. The pivot axis PA1 is oriented at angle relative the rotational axis RA1. In one or more embodiments, the pivot axis PA1 is perpendicular to the rotational axis RA1. In one or more embodiments, the pivot axis PA1 intersects the rotational axis RA1. In one or more embodiments, the pivot axis PA1 is offset by a distance (such as a few centimeters) from the rotational axis RA1. FIG. 3 shows the handle 220 rotated about the rotational axis RA1 from the first position shown in FIG. 2 to the second position shown in FIG. 3. The rotation of the handle 220 rotates one or more flange sections 213, 214 of the one or more locking pins 211, 212 relative to the housing 201. The rotational axis RA1 and the pivot axis PA1 shown are not limiting and are show for exemplary purposes. Other axes may be used. For example, a rotational axis may be offset from and/or non-parallel to a longitudinal axis of the actuator bar 241 described below. The rotational axis may be movable (e.g., pivotable) as shown for the rotational axis RA1, or the rotational axis can be stationary. As another example, a pivot axis may be offset from and/or parallel to the longitudinal axis of the actuator bar 241 described below. The pivot axis may be movable (e.g., linearly movable) as shown for the pivot axis PA1, or the pivot axis can be stationary.

After rotating the handle 220 to the second position shown in FIG. 3, the handle 220 is pivoted relative to the pivot axis PA1 and to the third position shown in FIG. 4. The pivoting of the handle 220 moves (e.g., slides) the one or more locking pins 211, 212 (e.g., along the Z-axis). In one or more embodiments, the one or more locking pins 211, 212 move (e.g., slide) toward the housing 201 and into the third position. In one or more embodiments, the first position shown in FIG. 2 is an unlocked position, the second position shown in FIG. 3 is an aligned position, and the third position shown in FIG. 4 is a locked position.

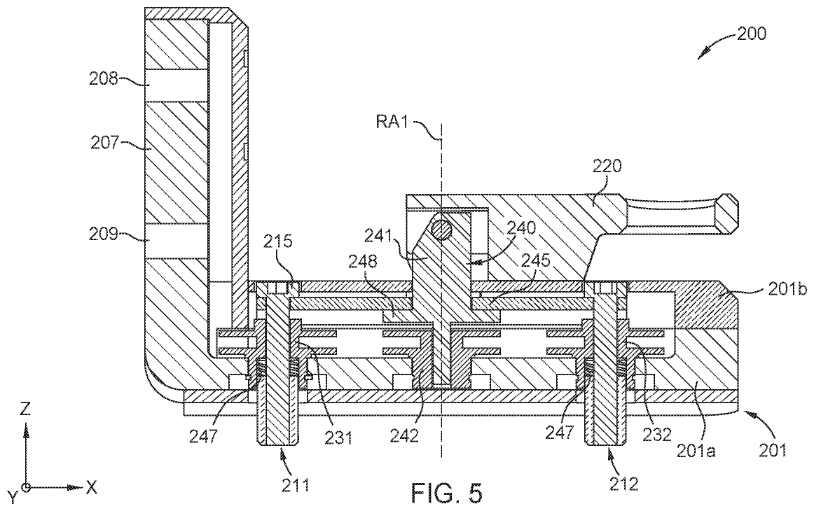

FIG. 5 is a schematic cross-sectional side view, along Section 5-5 shown in FIG. 4, of the mounting apparatus 200, according to one or more embodiments.

The housing 201 includes one or more bodies 201a, 201b (two are shown in FIG. 5). In one or more embodiments, a plurality of bodies 201a, 201b are coupled together. The mounting apparatus 200 includes one or more receptacles 231, 232, and the one or more locking pins 211, 212 are received respectively in the one or more receptacles 231, 232. The one or more receptacles 231, 232 are rotatable (e.g., about the Z-axis) relative to the housing 201, and the one or more locking pins 211, 212 are coupled to rotate with the one or more receptacles 231, 232. As an example, the locking pins 211, 212 can respectively include a section having a non-circular (e.g., rectangular or ovular) cross-section received in the respective receptacle 231, 232 such that rotation of the respective receptacle 231, 232 rotates the respective locking pin 211, 212. In one or more embodiments, the one or more locking pins 211, 212 are slidable (e.g., toward and away from the housing 201 along the Z-axis) relative to the one or more receptacles 231, 232 to abut against the mounting structure 112 and disengage from the mounting structure 112. The rotational axis RA1 is shown along the Z-axis and the pivot axis PA1 is shown along the Y-axis.

The mounting apparatus 200 includes an actuator 240 coupled to the handle 220. The actuator 240 includes an actuator bar 241, and the handle 220 is pivotably coupled to the actuator bar 241. The actuator bar 241 extends at least partially into the housing 201 and at least partially out of the housing 201. The actuator 240 also includes an actuator receptacle 242, and the actuator receptacle 242 is rotatable relative to the housing 201 (e.g., about the Z-axis). A plate 245 is disposed at least partially between the one or more locking pins 211, 212 and the actuator bar 241 of the actuator 240 to transfer linear movement between the actuator bar 241 and the one or more locking pins 211, 212. As an example, movement of the plate 245 along a first direction D1 moves the one or more locking pins 211, 212 toward the housing 201, and movement of the plate 245 along a second direction D2 allows the one or more locking pins 211, 212 to move away from the housing 201. For example, gravitational forces and/or biasing forces of one or more biasing elements 247 (such as springs) can move the one or more locking pins 211, 212 away from the housing 201. The one or more biasing elements 247 are disposed between the housing 201 and the one or more locking pins 211, 212.

In one or more embodiments, the actuator bar 241 and the one or more locking pins 211, 212 extend through the plate 245. In one or more embodiments, the actuator bar 241 includes an outer shoulder 248 configured to abut against the plate 245. The one or more locking pins 211, 212 respectively include a head section 215 configured to abut against the plate 245.

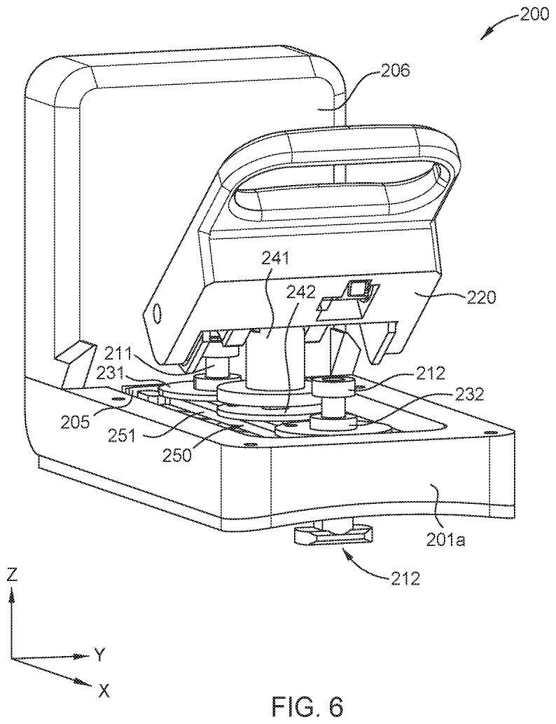

FIG. 6 is a schematic perspective view of the mounting apparatus 200 shown in FIGS. 2-5 with the second body 201b and the plate 245 hidden, according to one or more embodiments.

The mounting apparatus 200 includes one or more links 250 (one is shown) disposed such that rotation of the handle 220 moves the one or more links 250 to rotate the one or more locking pins 211, 212. For example, the one or more links 250 transfer rotational movement between the handle 220 and the one or more locking pins 211, 212. The one or more links 250 are coupled to the actuator 240. Rotation of the handle 220 (for example rotation between the first position shown in FIG. 2 and the second position shown in FIG. 3) transfers through the one or more links 250 to rotate the one or more locking pins 211, 212 into a blocking position relative to the mounting structure 112. When the one or more locking pins 211, 212 are in the blocking position, the one or more flange sections 213, 214 are oriented to abut against the mounting structure 112 when the one or more locking pins 211, 212 move (e.g., slide) toward the housing 201 along the Z-axis. The one or more receptacles 231, 232, and the actuator receptacle 242 are coupled to the one or more links 250. In one or more embodiments, rotation of any receptacle 231, 232, 242 (e.g., about the Z-axis) moves the one or more links 250 (e.g., along the X-Y plane), which in turn rotates the other two of the receptacles 231, 232, 242 (e.g., about the Z-axis). In one or more embodiments, the one or more receptacles 231, 232 include a pair of receptacles 231, 232 spaced from each other by at least a portion of the one or more links 250. In one or more embodiments, the one or more links 250 include a common link 251 coupled to the pair of receptacles 231, 232 and the actuator receptacle 242 of the actuator 240. In one or more embodiments, the one or more receptacles 231, 232 and/or the actuator receptacles 242 respectively include a wheel.

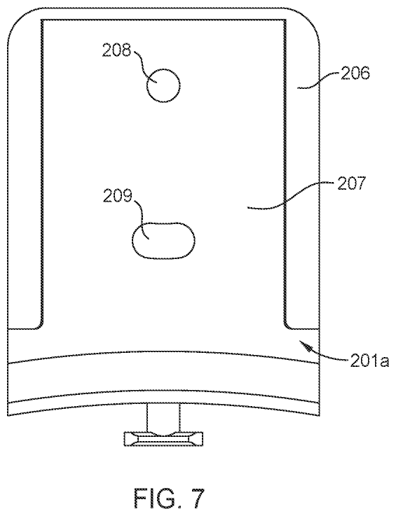

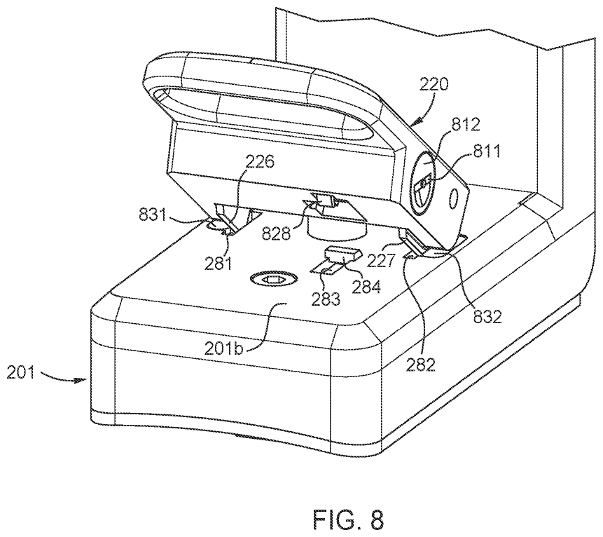

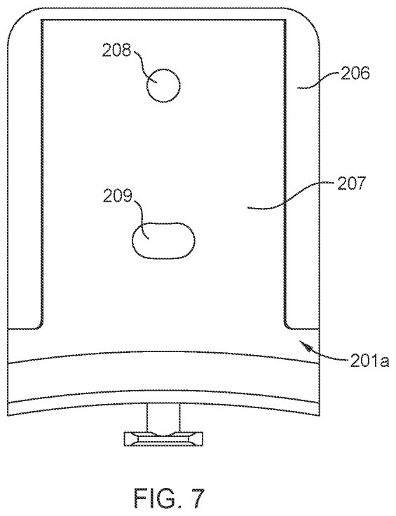

The mounting apparatus 200 includes a cover plate 206 slidable over at least a portion of the housing 201 (such as a portion of a mount plate 207 shown in FIG. 7). The cover plate 206 is slidable to receive at least one of the one or more links 250 in a retention opening 205 of the cover plate 206.

FIG. 7 is a schematic back view of the mounting apparatus 200 shown in FIGS. 2-6, according to one or more embodiments.

The first body 201a of the housing 201 includes the mount plate 207. The mount plate 207 includes a first opening 208 having a first size and a second opening 209 having a second size larger than the first size. In one or more embodiments, the first opening 208 is in the shape of a circle and the second opening 209 is in the shape of an elongated slot. Other shapes are contemplates for the first and second openings 208, 209. Fasteners (such as bolts) can extend through the openings 208, 209 and through a portion of the accessory 111 to couple the accessory 111 to the mount plate 207. The differing sizes of the openings 208, 209 allow for the accessory 111 to be adjustable with respect to the tilt of the accessory by moving a component (such as one of the fasteners) in the second opening 209 and tilting the accessory relative to the first opening 208. For example, the tilt can be adjusted to level the accessory 111 if the mounting structure 112 is not level.

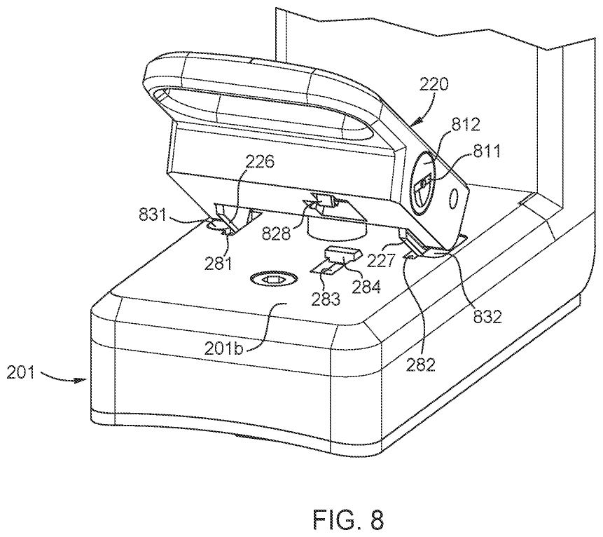

FIG. 8 is a schematic enlarged partial perspective view of the mounting apparatus 200 shown in FIGS. 2-5, according to one or more embodiments.

The second body 200b of the housing 201 includes one or more alignment openings 281, 282 (two are shown) sized and shaped to receive one or more alignment ledges 226, 227 (two shown) of the handle 220. The one or more alignment ledges 226, 227 moving into the one or more alignment openings 281, 282 helps to ensure that the handle 220 is rotated by a sufficient degree (e.g., about 90 degrees or another value) such that the one or more locking pins 211, 212 have moved into the blocking position. The one or more alignment openings 281, 282 also help to ensure that the handle 220 is not pivoted into the locked position until the handle 220 is properly rotated such that the one or more alignment ledges 226, 227 will move into the one or more alignment openings 281, 282. In one or more embodiments, the handle 220 abuts against one or more blocks 831, 832 (a pair of blocks are shown in FIG. 8) as the handle 220 pivots into and out of the locked position. The one or more blocks 831, 832 are disposed in one or more block openings (e.g., recesses) of the second body 201b.

The second body 200b of the housing 201 includes a retention opening 283, and a latch 828 is coupled to the handle 220. The latch 828 is sized and shaped to extend through the retention opening 283 and behind a ledge 284 of the second body 200b of the housing 201 when a latch actuator 810 is actuated. In one or more embodiments, a key can be inserted into a slot 811 of the latch actuator 810 when the mounting apparatus 200 is in the third position (e.g., the locked position), and the key can be turned to rotate a barrel 812 of the latch actuator 810. The rotation of the barrel 812 pivots the latch 828 to extend through the retention opening 283 and behind the ledge 284. The latch 828 extending through the retention opening 283 and behind the ledge 284 locks the handle 220 in place relative to the second body 201b of the housing 201. For example, the latch 828 abutting against the ledge 284 helps to ensure that the mounting apparatus 200 does not become unlocked without user manipulation. For example, the latch 828 abutting against the ledge 284 resists gravitational forces and/or biasing forces of the one or more biasing elements 247 that may pull on the handle 220. The latch 828 abutting against the ledge 284 also can resist certain incidental forces acting on the handle 220 (e.g., by a user) that are not intended to unlock the mounting apparatus 200. Additionally, the latch 828 abutting against the ledge 284 resists the mounting apparatus 200 (and the mounted accessory) becoming unlocked without first using the key to unlock the barrel 812 of the latch actuator 810.

The present disclosure contemplates that sections and/or components of the mounting apparatus 200 can be formed of a metal (such as aluminum or steel) and/or non-metallic materials, such as polymer materials (for example additive manufactured (e.g., 3-D printed) glass-filled nylon).

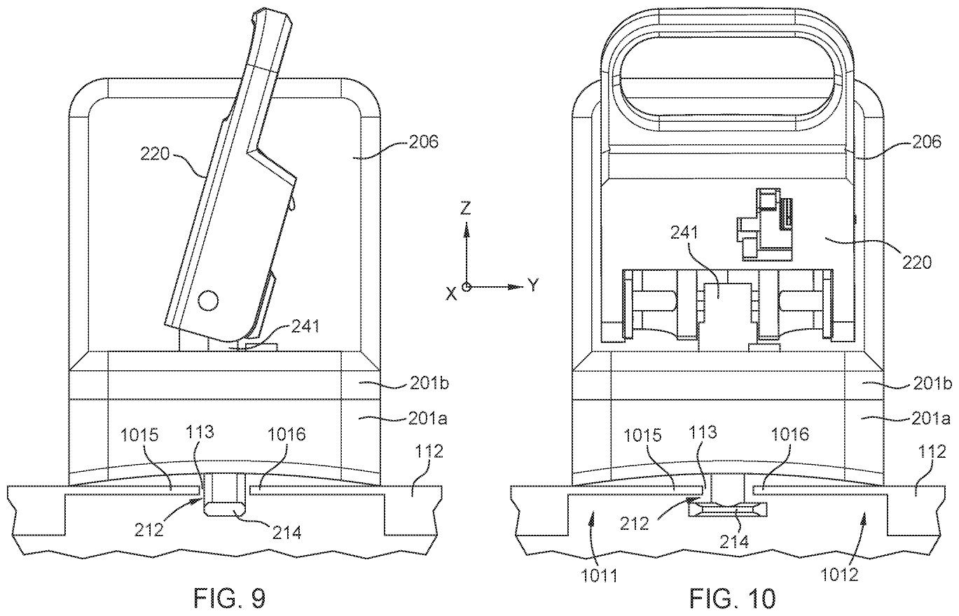

FIG. 9 is a schematic side view of the mounting apparatus 200 in the first position shown in FIG. 2, according to one or more embodiments.

In the first position, the one or more flange sections 213, 214 are oriented parallel to an opening 113 of the mounting structure 112 such that the one or more flange sections 213, 214 can be positioned through the opening 113.

FIG. 10 is a schematic side view of the mounting apparatus 200 in the second position shown in FIG. 3, according to one or more embodiments.

In the second position, a user has rotated the handle 220 such that the one or more flange sections 213, 214 are rotated to extend into channel sections 1011, 1012 on opposite sides of the opening 113. In FIG. 10, the one or more flange sections 213, 214 are in an obstructed position such that the one or more flange sections 213, 214 contact the mounting structure 112 when the one or more flange sections 213, 214 are moved upwardly.

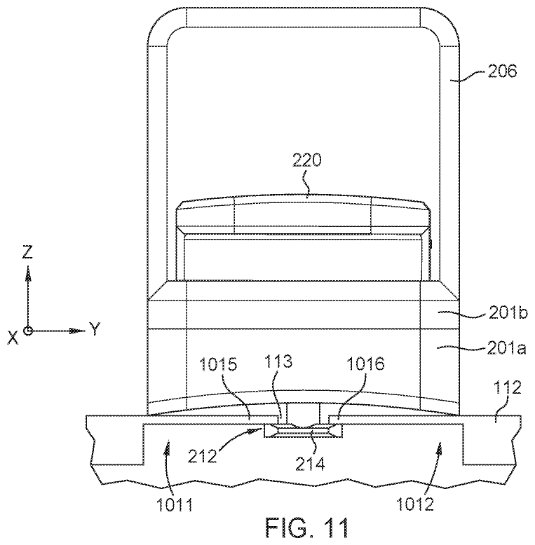

FIG. 11 is a schematic side view of the mounting apparatus 200 in the third position shown in FIG. 4, according to one or more embodiments.

In the third position, the handle 220 is pivoted toward the second body 201b of the housing 201, causing the one or more flange sections 213, 214 of the one or more locking pins 211, 212 to abut against opposing plate sections 1015, 1016 of the mounting structure 112 (e.g., the crossbar) and lock the mounting apparatus 200 to the mounting structure 112. The accessory 111 (such as an awning) can then be mounted to the housing 201 using fasteners extending through the first and second openings 208, 209.

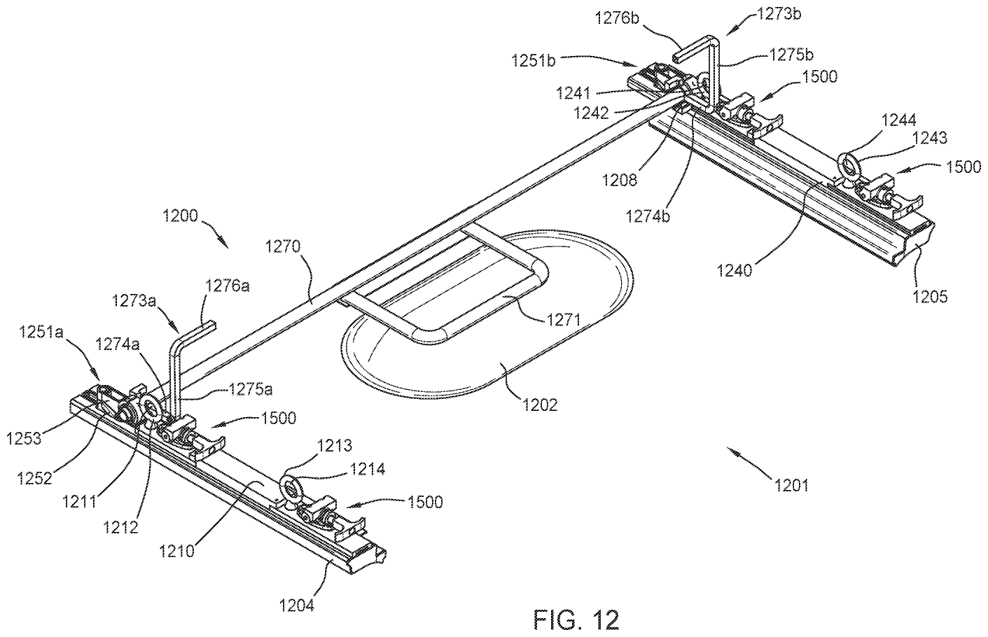

FIG. 12 is a schematic perspective view of a collapsible retention apparatus 1200 in a first position, according to one or more embodiments. In one or more embodiments, the first position is a collapsed position.

The collapsible retention apparatus 1200 includes a first support rail 1210, and a second support rail 1240 spaced from the first support rail 1210 to define a spacing 1201 therebetween. The collapsible retention apparatus 1200 includes a shaft 1270 coupled to the first and second support rails 1210, 1240. The shaft 1270 is movable (e.g., rotatable) relative to the first and second support rails 1210, 1214. The collapsible retention apparatus 1200 includes a blocking structure 1271 coupled to the shaft 1270, and movement (e.g., rotation) of the shaft 1270 moves (e.g., pivots) the blocking structure 1271 into and out of the spacing 1201. In one or more embodiments, the blocking structure 1271 includes a handle, as shown in FIG. 12. FIG. 12 shows the blocking structure 1271 positioned in the spacing 1201 to at least partially obstruct a retention opening 1202. The retention opening 1202 can be formed in a vehicle, such as in a floor of a cab of the vehicle. The retention opening 1202 can retain at least part of a component (such as a spare off-road tire) to securely retain or support the component during driving of the vehicle (e.g., during vehicle braking, acceleration, and cornering). When the collapsible retention apparatus 1200 is in the first position (e.g., the collapsed position), the retention opening 1202 is obstructed such that the component is obstructed from being positioned in the retention opening 1202.

The collapsible retention apparatus 1200 includes one or more extensions 1273a, 1273b (a pair of extensions is shown) coupled to the shaft 1270 and extending relative to the shaft 1270. At least one (such as one or all) of the one or more extensions 1273a, 1273b includes a first section 1274a, 1274b extending radially outwardly relative to the shaft 1270, a second section 1275a, 1275b extending tangentially to the shaft 1270, and a third section 1276a, 1276b extending parallel to the shaft 1270. The first support rail 1210 includes a first support opening 1211, and the second support rail 1240 includes a second support opening 1241. In one or more embodiments, the first support opening 1211 is defined by a first eyelet 1212 and the second support opening 1241 is defined by a second eyelet 1242. The first and second support rails 1210, 1240 respectively can include one or more additional eyelets 1213, 1243 defining one or more additional support openings 1214, 1244.

At least one mounting apparatus 1500 is coupled respectively to the first support rail 1210 and the second support rail 1240. FIG. 12 shows two mounting apparatus 1500 coupled respectively to the first support rail 1210 and the second support rail 1240. The mounting apparatus 1500 are used to mount the first and second support rails 1210, 1240 to a mount structure. The mount structure includes a pair of vehicle rails 1204, 1205. The vehicle rails 1204, 1205 can be disposed in or outside a cab of a vehicle. For example, the vehicle rails 1204, 1205 can be coupled to a floor in the cab or to a roof of the vehicle.

The first support rail 1210 and the second support rail 1240 respectively are coupled to a hinge assembly 1251a, 1251b that includes a first arm 1252 pivotably coupled to a second arm 1253. The first arm 1252 is coupled to the respective support rail 1210, 1240 and the shaft 1270 is disposed at least partially in a section of the second arm 1253. The first arm 1252 is pivotable relative to the second arm 1253 to pivot the respective support rail 1210, 1240 toward the shaft 1270 such that the collapsible retention apparatus 1200 can be stored with a reduced footprint when the support rails 1210, 1240 are removed from the vehicle rails 1204, 1205.

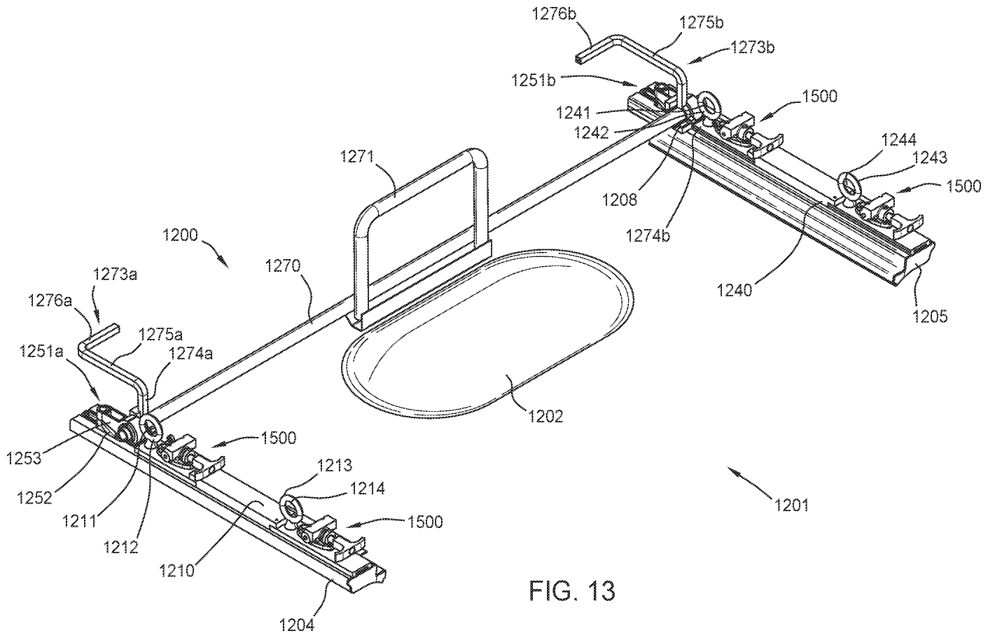

FIG. 13 is a schematic perspective view of the collapsible retention apparatus 1200 in a second position, according to one or more embodiments. In one or more embodiments, the second position is an extended position.

In the second position (e.g., the extended position), the shaft 1270 has been moved (e.g., rotated) to move (e.g., pivot) the blocking structure 1271 and the one or more extensions 1273a, 1273b away from the support rails 1210, 1240. The blocking structure 1271 moves to clear the retention opening 1202 such that the component (e.g., the tire) can be positioned in the retention opening 1202. The one or more extensions 1273a, 1273b can abut against part(s) of the vehicle, such as one or more seatbacks in the vehicle. For example, in FIG. 12 the one or more seatbacks can be upright to restrict pivoting of the one or more extensions 1273a, 1273b, and in FIG. 13 the one or more seatbacks can be collapsed downwardly such that the one or more extensions 1273a, 1273b can pivot and pivot the blocking structure 1271 to clear the retention opening 1202. After the component is positioned in the retention opening 202, the component can be coupled to the first and second support rails 1210, 1240 using devices (such as hooks of ratchet straps or other tie-down devices) extending into the support openings 1211, 1214, 1241, 1244 and coupled to the eyelets 1212, 1213, 1242, 1243. The component can be removed from the retention opening 1202, and the blocking structure 1271 and the one or more extensions 1273a, 1273b can be pivoted back to the first position such that the one or more seatbacks can be extended back to the upright position. Hence, the one or more seatbacks can be collapsed and expanded, and the component can be positioned in and out of the retention opening 1202, without dismounting the collapsible retention apparatus 1200 from the vehicle rails 1204, 1205.

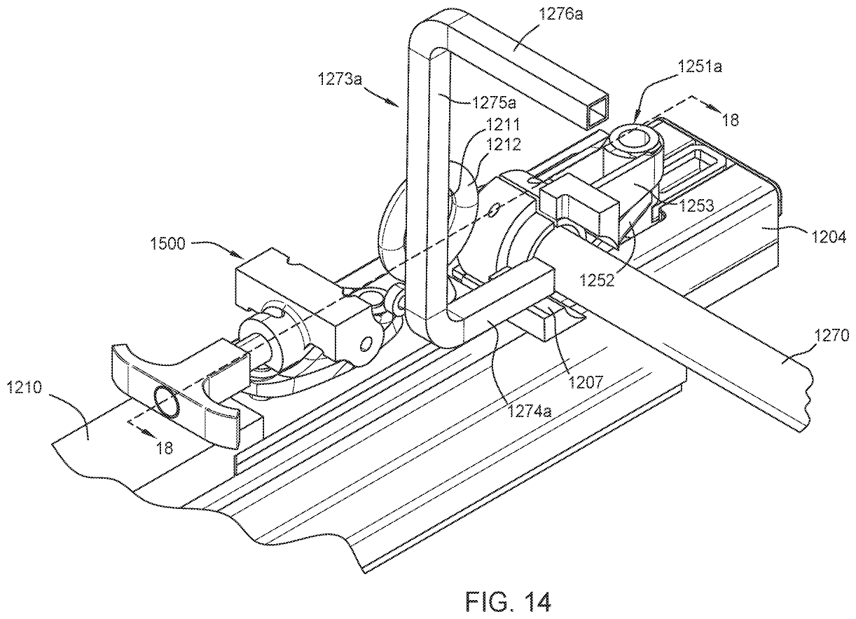

FIG. 14 is a schematic enlarged perspective view of the first support rail 1210 shown in FIG. 12, according to one or more embodiments.

As shown in FIGS. 12 and 14, in one or more embodiments the one or more extensions 1273a, 1273b include a first extension 1273a positioned to abut against a first surface 1207 of the first support rail 1210, and a second extension 1273b positioned to abut against a second surface 1208 of the second support rail 1240.

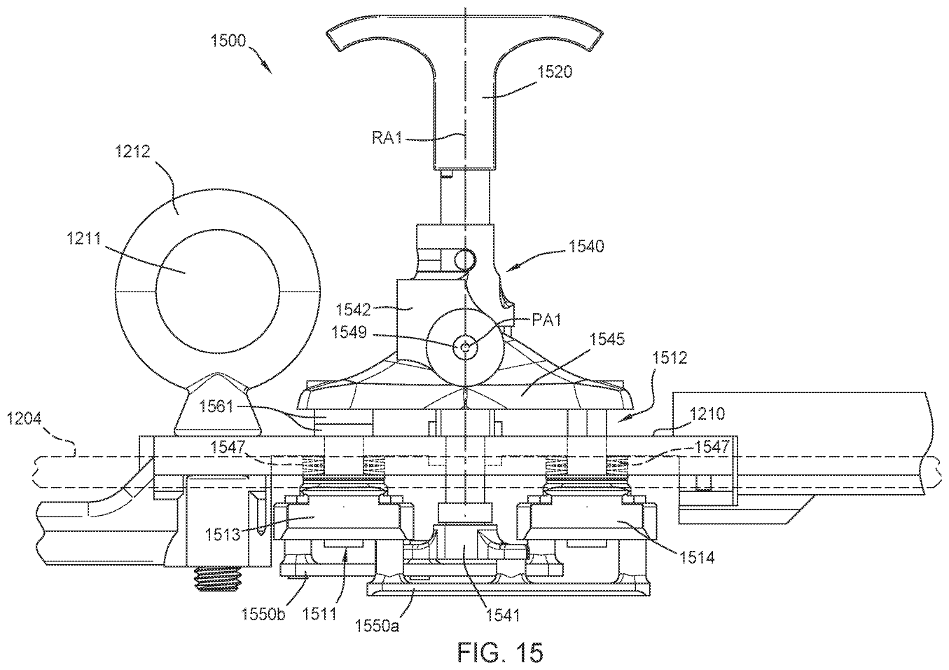

FIG. 15 is a schematic side view of the mounting apparatus 1500 shown in FIG. 14 in a first position, according to one or more embodiments.

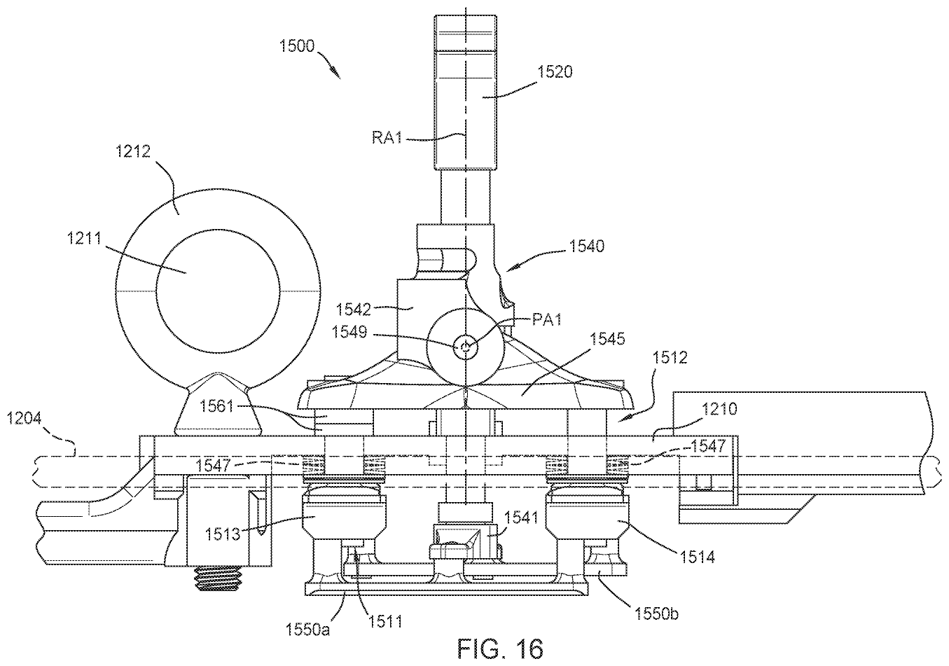

FIG. 16 is a schematic side view of the mounting apparatus 1500 shown in FIG. 15 in a second position, according to one or more embodiments.

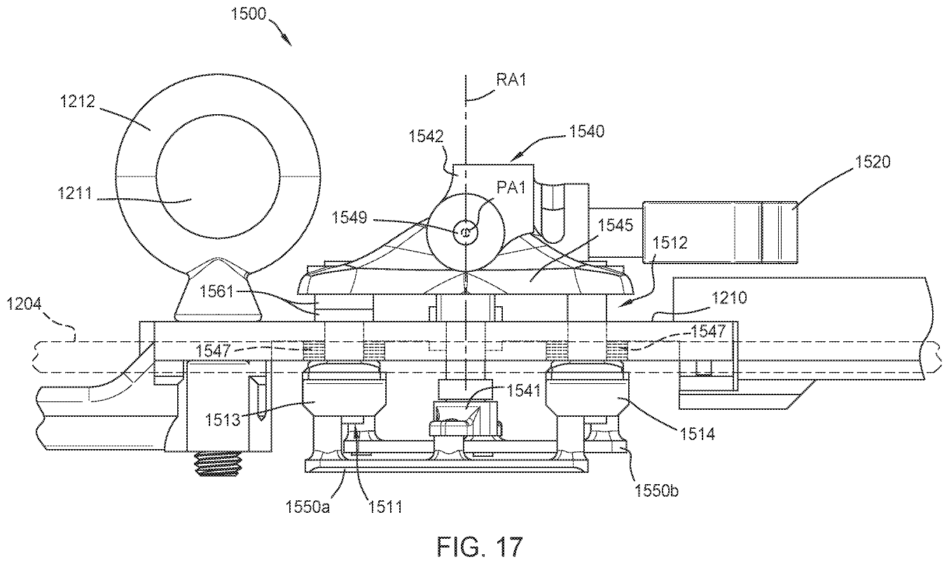

FIG. 17 is a schematic side view of the mounting apparatus 1500 shown in FIG. 16 in a third position, according to one or more embodiments.

FIGS. 15-17 will be described together. The mounting apparatus 1500 includes one or more locking pins 1511, 1512 (two are shown) extending through a plate 1545 and at least part of (such as a plate section of) the first support rail 1210. The mounting apparatus 1500 includes a handle 1520 configured to rotate relative to (e.g., about) the rotational axis RA1 and pivot relative to the pivot axis PA1. FIG. 16 shows the handle 1520 rotated about the rotational axis RA1 from the first position shown in FIG. 15 to the second position shown in FIG. 16. The rotation of the handle 1520 rotates one or more flange sections 1513, 1514 of the one or more locking pins 1511, 1512 relative to the plate 1545. One or more spacers 1561 (a plurality is shown) are disposed about at least one of the one or more locking pins 1511, 1512.

After rotating the handle 1520 to the second position shown in FIG. 16, the handle 1520 is pivoted relative to the pivot axis PA1 and to the third position shown in FIG. 17. The pivoting of the handle 1520 moves (e.g., slides) the one or more locking pins 1511, 1512 (e.g., along the Z-axis). In one or more embodiments, the one or more locking pins 1511, 1512 move (e.g., slide) toward the plate 1545 and the handle 1520 and into the third position. In one or more embodiments, the first position shown in FIG. 15 is an unlocked position, the second position shown in FIG. 16 is an aligned position, and the third position shown in FIG. 17 is a locked position.

The mounting apparatus 1500 includes an actuator 1540 coupled to the handle 1520. The actuator 1540 includes an actuator bar 1541 received at least partially in an actuator receptacle 1542. The handle 1520 is pivotably coupled to the actuator bar 1541. The actuator bar 1541 extends through the at least part of the first support rail 1210, through the plate 1545, and into the actuator receptacle 1542. The handle 1520 is rotatable relative to the actuator receptacle 1542 (e.g., about the Z-axis), and the actuator receptacle 1542 pivots with the handle 1520 relative to the plate 1545. The actuator bar 1541 is coupled to rotate with the handle 1520. The one or more locking pins 1511, 1512 rotate relative to the plate 1545 in response to rotation of the handle 1520. The plate 1545 is disposed at least partially between the one or more locking pins 1511, 1512 and the actuator bar 1541 of the actuator 1540.

A pivot pin 1549 extends in at least part of the handle 1520 and at least part of the actuator bar 1541 to pivotably couple the handle 1520 to the actuator bar 1541. The pivot pin 1549 extends in at least part of the actuator receptacle 1542 and at least part of the plate 1545 to pivotably couple the actuator receptacle 1542 to the plate 1545.

In one or more embodiments, the one or more locking pins 1511, 1512 are slidable (e.g., toward and away from the handle 1520 along the Z-axis) to abut against the first vehicle rail 1204 and disengage from the first vehicle rail 1204. The first vehicle rail 1204 is shown in ghost in FIGS. 15-17. The handle 1520 can function as a cam such that pivoting of the handle 1520 imparts linear motion to the actuator bar 1541. As an example, the pivoting of the handle 1520 and the actuator receptacle 1542 drives the actuator bar 1541 to move the one or more locking pins 1511, 1512 (e.g., toward and away from the handle 1520 and the pivot pin 1549). For example, movement of the actuator bar 1541 along the first direction D1 moves the one or more locking pins 1511, 1512 toward the handle 1520 and the pivot pin 1549, and movement of the actuator bar 1541 along the second direction D2 moves the one or more locking pins 1511, 1512 away from the handle 1520. Gravitational forces and/or biasing forces of one or more biasing elements 1547 (such as springs) can move the one or more locking pins 1511, 1512 away from the handle 1520. In one or more embodiments, the biasing elements 1547 include spring washers. In one or more embodiments, the biasing elements 1547 respectively include springs stacked on each other, such as cone-shaped spring washers stacked on each other. The one or more biasing elements 1547 are disposed between the plate 1545 and the one or more locking pins 1511, 1512.

The mounting apparatus 1500 includes one or more links 1550a, 1550b (two are shown) disposed such that rotation of the handle 1520 moves the one or more links 1550a, 1550b to rotate the one or more locking pins 1511, 1512. For example, the one or more links 1550a, 1550b transfer rotational movement between the handle 1520 and the one or more locking pins 1511, 1512. The one or more links 1550a, 1550b are also disposed to transfer linear movement between the actuator bar 1541 and the one or more locking pins 1511, 1512. The one or more links 1550a, 1550b are coupled to the actuator bar 1541 of the actuator 1540. Rotation of the handle 1520 (for example, rotation between the first position shown in FIG. 15 and the second position shown in FIG. 16) transfers through the one or more links 1550a, 1550b to rotate the one or more locking pins 1511, 1512 into a blocking position relative to the first vehicle rail 1204. When the one or more locking pins 1511, 1512 are in the blocking position, the one or more flange sections 1513, 1514 are oriented to abut against the first vehicle rail 1204 when the one or more locking pins 1511, 1512 move (e.g., slide) toward the handle 1520 along the Z-axis. In one or more embodiments, the one or more links 1550a, 1550b include a first link 1550a and a second link 1550b. The first link 1550a and the second link 1550b respectively are coupled to the actuator bar 1541, a first flange section 1513 of a first locking pin 1511, and a second flange section 1514 of a second locking pin 1512. Rotation of the actuator bar 1541 (e.g., about the Z-axis) moves the one or more links 1550a, 1550b (e.g., along the X-Y plane), which in turn rotates the one or more locking pins 1511, 1512 (e.g., about the Z-axis). In one or more embodiments, the first and second links 1550a, 1550b are common links.

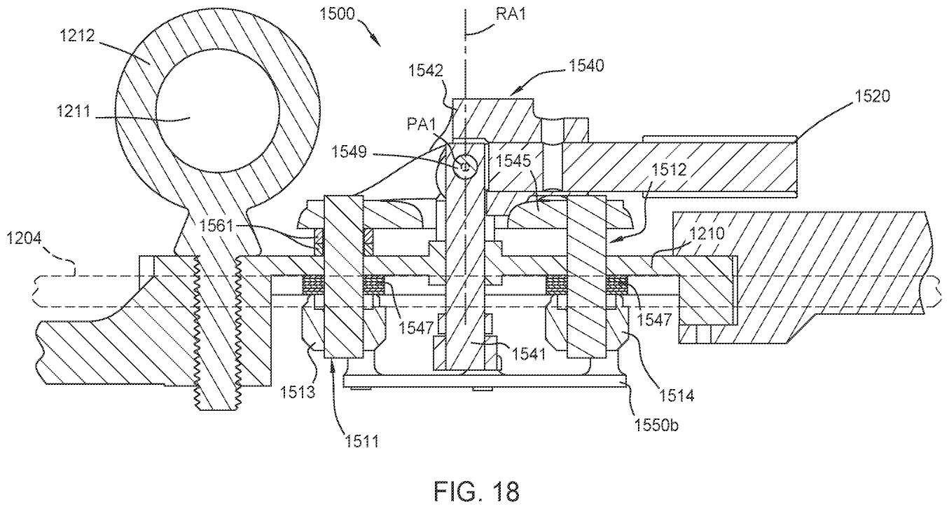

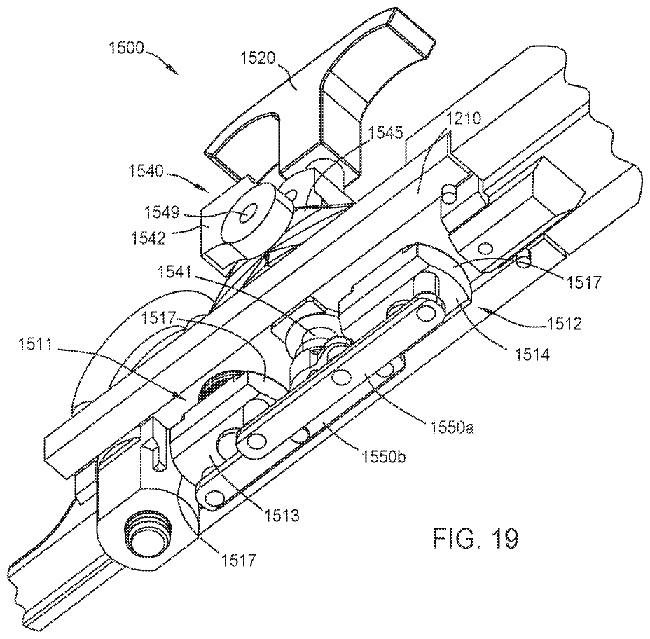

FIG. 18 is a schematic side cross-sectional view of the mounting apparatus 1500 along Section 18-18 shown in FIG. 14 in the third position, according to one or more embodiments. FIG. 19 is a schematic bottom view of mounting apparatus 1500 shown in FIG. 16 in the second position, according to one or more embodiments.

In one or more embodiments, at least one (such as one or all) of the one or more flange sections 1513, 1514 includes a curved outer edge 1517. In one or more embodiments, the one or more flange sections 1513, 1514 respectively include opposing curved outer edges 1517.

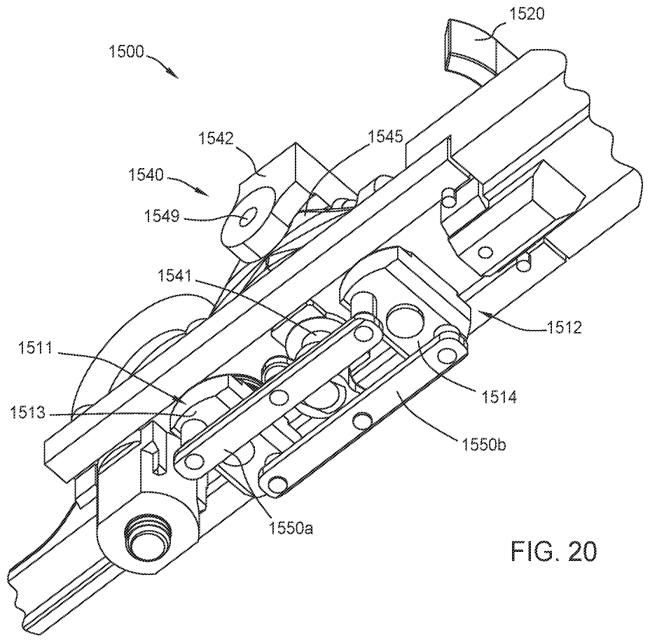

FIG. 20 is a schematic bottom view of mounting apparatus 1500 shown in FIG. 17 in the third position, according to one or more embodiments.

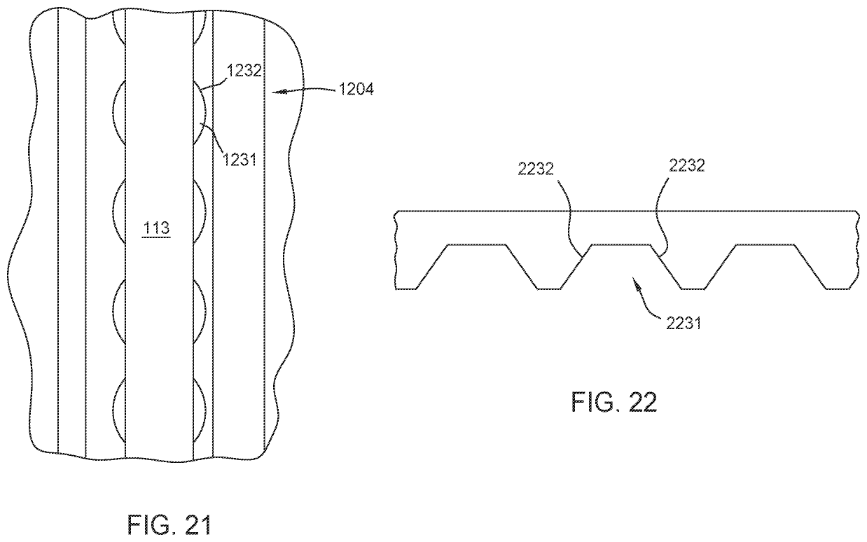

FIG. 21 is a schematic bottom view of the first vehicle rail 1204 shown in FIGS. 12-14, according to one or more embodiments. The first vehicle rail 1204 includes a plurality of recesses 1231 on a bottom side of the first vehicle rail 1204. The recesses 1231 are semi-circular in shape. The recesses 1231 can be scalloped into the first vehicle rail 1204. As the mounting apparatus 1500 is moved into the third position, the one or more flange sections 1513, 1514 can move into a subset of the recesses 1231. As the one or more flange sections 1513, 1514 rotate into the third position, the one or more flange sections 1513, 1514 can abut against edges 1232 defined by the recesses 1231 to center the locking pins 1511, 1512 relative to the opening 113 of the first vehicle rail 1204. The opening 113 can be enclosed by the first vehicle rail 1204 at one or both ends of the opening 113. After the one or more flange sections 1513, 1514 are in the third position, the edges 1232 restrict movement (such as linear movement of the mounting apparatus 1500 along a longitudinal axis of the first vehicle rail 1204). The second vehicle rail 1205 can include the recesses 1231 in the same manner.

FIG. 22 is a schematic bottom view of the first vehicle rail 1204 shown in FIG. 21, according to one or more embodiments.

The first vehicle rail 1204 includes a plurality of recesses 2231. The recesses 2213 include one or more tapered edges 2232. The one or more tapered edges 2232 can guide the one or more flange sections 1513, 1514 into the recesses 2231 as the locking pins 1511, 1512 slide toward the pivot pin 1549 and the actuator receptacle 1542 and into the third position. After the one or more flange sections 1513, 1514 are in the third position, the tapered edges 2232 restrict movement (such as linear movement of the mounting apparatus 1500 along a longitudinal axis of the first vehicle rail 1204).

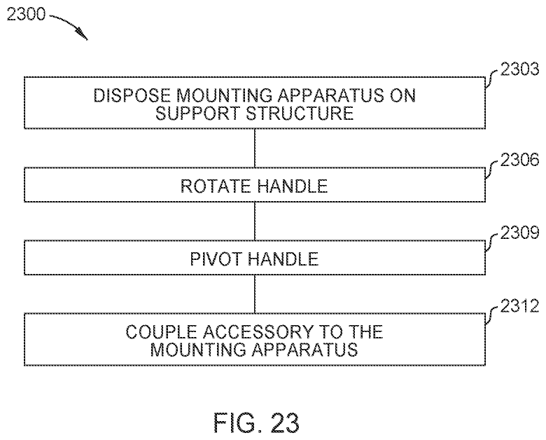

FIG. 23 is a schematic block diagram view of a method 2300 of mounting an accessory, according to one or more embodiments.

The description of the method 2300 includes reference to reference numerals shown in FIGS. 1-11, and the present disclosure contemplates that subject matter (such as structures and components) other than the subject matter shown in FIGS. 1-11 can be used in relation to the method 2300. For example, the mounting apparatus 1500 can be used in relation to the method 2300.

Operation 2303 includes disposing the mounting apparatus 200 on the mounting structure 112. In one or more embodiments, the disposing includes positioning the one or more flange sections 213, 214 of the one or more locking pins 211, 212 through the opening 113.

Operation 2306 includes rotating the handle 220 to rotate the one or more flange sections 213, 214 of the one or more locking pins 211, 212.

Operation 2309 includes pivoting the handle 220 toward the housing 201 to abut the one or more flange sections 213, 214 of the one or more locking pins 211, 212 against the plate sections 1015, 1016 of the mounting structure 112.

Operation 2312 includes coupling (e.g., fastening) the accessory 111 to the mount plate 207 of the mounting apparatus 200. The present disclosure contemplates that operation 2312 can be conducted before operation 2303 or after operation 2309.

Using the handle 220, the present disclosure contemplates that a user may conduct various operations described herein (such as operations 2303, 2306, 2309 of the method 2300) using one hand and without tools (such as a wrench or screwdriver), which enables quick and easy mounting and dismounting of accessories to and from vehicles. Moreover, the quick and easy dismounting (e.g., releasing) of the mounting apparatus 200 facilitates reduced vehicle footprints and enhanced aerodynamic efficiencies. The mounting apparatus 200 can also be quickly dismounted and stored in the vehicle or another enclosed space. The one or more locking pins 211, 212 can extend through the opening 113 at any position along the opening 113 such that the mounting apparatus 200 can be locked to the mounting structure 112 at any position along the opening 113.

The present disclosure contemplates that the subject matter described herein may be expressed in one or more of the following Examples:
1. A collapsible retention apparatus, comprising:
   a first support rail;
   a second support rail spaced from the first support rail to define a spacing therebetween;
   a shaft coupled to the first and second support rails, the shaft rotatable relative to the first and second support rails; and
   a blocking structure coupled to the shaft, wherein rotation of the shaft moves the blocking structure into and out of the spacing.
2. The collapsible retention apparatus of Example 1, further comprising one or more extensions coupled to the shaft and extending relative to the shaft, wherein the blocking structure comprises a handle.
3. The collapsible retention apparatus of Example 3, wherein the one or more extensions comprise:
   a first extension positioned to abut against a first surface of the first support rail; and
   a second extension positioned to abut against a second surface of the second support rail.
4. The collapsible retention apparatus of Example 2, wherein at least one of the one or more extensions comprises:
   a first section extending radially outwardly relative to the shaft;
   a second section extending tangentially to the shaft; and
   a third section extending parallel to the shaft.
5. The collapsible retention apparatus of Example 1, wherein the first support rail comprises a first support opening, and the second support rail comprises a second support opening.
6. The collapsible retention apparatus of Example 1, further comprising a mounting apparatus coupled to the first support rail, the mounting apparatus comprising:
   one or more locking pins extending through at least part of the first support rail;
   a handle configured to rotate relative to a rotational axis and pivot relative to a pivot axis; and
   one or more links, wherein rotation of the handle moves the one or more links to rotate the one or more locking pins into a blocking position relative to a mounting structure.

Benefits of the present disclosure include reliable, quick, and ease of mounting an accessory to a vehicle; enhanced strength of locking and reduced or eliminated chances of damage to rails and/or crossbars; locking mounting apparatus using one hand and without driving tools (such as a wrench or screwdriver); reliable, quick, and ease of unlocking mounting apparatus from the crossbar and/or rail; enhanced vehicle aerodynamics; reduced vehicle footprints (which allow vehicles to move through smaller clearances); and quick and easy storage of accessories and/or mounting apparatus in the vehicle or another enclosed area. For example, the benefits include securely and reliably retaining large and/or heavy components (such as a spare tire).

It is contemplated that one or more aspects disclosed herein may be combined. As an example, one or more aspects, features, components, operations and/or properties of the vehicle 100, the accessory 111, the mounting apparatus 200, the mounting structure 112, the implementations shown in FIGS. 9-11, the collapsible retention apparatus 1200, the first vehicle rail 1204, the second vehicle rail 1205, the recesses 1231, the recesses 2231, the mounting apparatus 1500, and/or the method 2300 may be combined. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

What is claimed is:

1. A mounting apparatus, comprising:
one or more locking pins;
one or more links; and
a handle configured to rotate and pivot, wherein rotation of the handle moves the one or more links to rotate the one or more locking pins into a blocking position relative to a mounting structure, and pivoting of the handle moves the locking pins toward the handle and into a locked position.

2. The mounting apparatus of claim 1, further comprising:
one or more receptacles coupled to the one or more links, wherein the one or more locking pins are received respectively in the one or more receptacles, wherein the one or more receptacles are rotatable relative to a housing, and the one or more locking pins are coupled to rotate with the one or more receptacles.

3. The mounting apparatus of claim 1, wherein the one or more locking pins are slidable relative to an actuator to abut against the mounting structure.

4. The mounting apparatus of claim 1, further comprising a cover plate slidable over at least a portion of a housing, wherein the cover plate is configured to receive at least one of the one or more links in a retention opening of the cover plate.

5. The mounting apparatus of claim 2, wherein the one or more receptacles comprise a pair of receptacles spaced from each other by at least a portion of the one or more links.

6. The mounting apparatus of claim 1, further comprising:
an actuator coupled to the handle and the one or more links.

7. The mounting apparatus of claim 6, wherein the actuator comprises:
an actuator bar, wherein the handle is pivotably coupled to the actuator bar.

8. The mounting apparatus of claim 6, wherein the actuator comprises:
an actuator receptacle, wherein the actuator receptacle is rotatable relative to a housing.

9. A mounting apparatus, comprising:
one or more locking pins;
an actuator bar, wherein the actuator bar is rotatable rotate relative to a rotational axis to rotate the one or more locking pins and slidable along the rotational axis to slide the one or more locking pins; and
a plate disposed at least partially between the actuator bar and the one or more locking pins.

10. The mounting apparatus of claim 9, further comprising a handle pivotably coupled to the actuator bar.

11. The mounting apparatus of claim 9, wherein the actuator bar and the one or more locking pins extend through the plate.

12. The mounting apparatus of claim 11, wherein the actuator bar comprises an outer shoulder configured to abut against the plate.

13. The mounting apparatus of claim 11, wherein the one or more locking pins comprise a head section configured to abut against the plate.

14. The mounting apparatus of claim 9, further comprising one or more biasing elements disposed between the plate and the one or more locking pins.

15. A mounting apparatus, comprising:
an actuator;
a handle pivotably coupled to the actuator; and
one or more locking pins comprising one or more flange sections, wherein:
rotation of the handle rotates the one or more flange sections of the one or more locking pins, and
pivoting of the handle slides the one or more locking pins.

16. The mounting apparatus of claim 15, further comprising a housing that comprises one or more alignment openings sized and shaped to receive one or more alignment ledges of the handle.

17. The mounting apparatus of claim 15, further comprising a housing that comprises a retention opening, wherein the handle comprises a latch sized and shaped to extend through the retention opening and behind a ledge of the housing to lock the handle in place relative to the housing.

18. The mounting apparatus of claim 15, further comprising:
a plate disposed at least partially between the actuator and the one or more locking pins.

19. The mounting apparatus of claim 15, further comprising a housing, the housing comprising a mount plate comprising a first opening having a first size and a second opening having a second size larger than the first size, wherein a tilt of an accessory is adjustable by moving a component in the second opening and tilting the accessory relative to the first opening.

20. The mounting apparatus of claim 15, wherein at least one of the one or more flange sections comprises a curved outer edge.
